(19) United States
(12) Patent Application Publication
(10) Pub. No.: US 2011/0055234 A1
(43) Pub. Date: Mar. 3, 2011

(54) METHOD AND APPARATUS FOR COMBINING CONTACT LISTS

(75) Inventor: Timo Kristian MIETTINEN, Espoo (FI)

(73) Assignee: Nokia Corporation, Espoo (FI)

(21) Appl. No.: 12/552,869

(22) Filed: Sep. 2, 2009

(51) Int. Cl. G06F 17/30

(52) U.S. Cl. 707/755; 707/E17.033

(57) ABSTRACT

An approach is provided for combining contact lists using partial word matching. A first contact list associated with initiating communication over one or more communication networks is retrieved from memory. A second contact list is received. The second contact list is merged with the first contact list. For each entry of the first contact list, an identifier is parsed into one or more words. For each entry of the second contact list, an identifier is parsed into one or more words. Whether the one or more words of the identifier of the first contact list partially matches the one or more words of the identifier of the second contact list is determined.

### BACKGROUND

Wireless (e.g., cellular) service providers and device manufacturers are continually challenged to deliver value and convenience to consumers by, for example, providing compelling network services. Challenges in this field include integrating network services to onto a single device. However, many times it is difficult to integrate various network services with a device.

### SOME EXAMPLE EMBODIMENTS

According to one embodiment, a method comprises retrieving from memory a first contact list associated with initiating communication over one or more communication networks and receiving a second contact list. The method also comprises merging the second contact list with the first contact list by: parsing, for each entry of the first contact list, an identifier into one or more words, parsing, for each entry of the second contact list, an identifier into one or more words, and determining whether the one or more words of the identifier of the first contact list partially matches the one or more words of the identifier of the second contact list.

According to another embodiment, an apparatus comprising at least one processor, and at least one memory including computer program code, the at least one memory and the computer program code configured to, with the at least one processor, cause the apparatus to retrieve from memory a first contact list associated with initiating communication over one or more communication networks. The apparatus is also caused to receive a second contact list. The apparatus is further caused to merge the second contact list with the first contact list by causing the apparatus to parse, for each entry of the first contact list, an identifier into one or more words, parse, for each entry of the second contact list, an identifier into one or more words, and determine whether the one or more words of the identifier of the first contact list partially matches the one or more words of the identifier of the second contact list.

According to another embodiment, a computer-readable storage medium carrying one or more sequences of one or more instructions which, when executed by one or more processors, cause an apparatus to retrieve from memory a first contact list associated with initiating communication over one or more communication networks. The apparatus is also caused to receive a second contact list. The apparatus is further caused to merge the second contact list with the first contact list by causing the apparatus to parse, for each entry of the first contact list, an identifier into one or more words, parse, for each entry of the second contact list, an identifier into one or more words, and determine whether the one or more words of the identifier of the first contact list partially matches the one or more words of the identifier of the second contact list.

According to another embodiment, an apparatus comprises means for retrieving from memory a first contact list associated with initiating communication over one or more communication networks and means for receiving a second contact list. The apparatus also comprises means for merging the second contact list with the first contact list using means for parsing, for each entry of the first contact list, an identifier into one or more words; means for parsing, for each entry of the second contact list, an identifier into one or more words; and means for determining whether the one or more words of the identifier of the first contact list partially matches the one or more words of the identifier of the second contact list.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of combining contact lists, according to one embodiment;

FIG. 2 is a diagram of the components of a user equipment, according to one embodiment;

FIG. 3 is a flowchart of a process for combining contact lists using unique identifiers or full names, according to one embodiment;

FIG. 4 is a flowchart of a process for combining contact lists using partial and ambiguous name matching, according to one embodiment;

FIG. 5 is a flowchart of a process for combining contact lists, according to one embodiment;

FIGS. 6A-6B are diagrams of user interfaces utilized in the processes of FIGS. 4 and 5, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

A method, apparatus, and software for combining contact lists are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

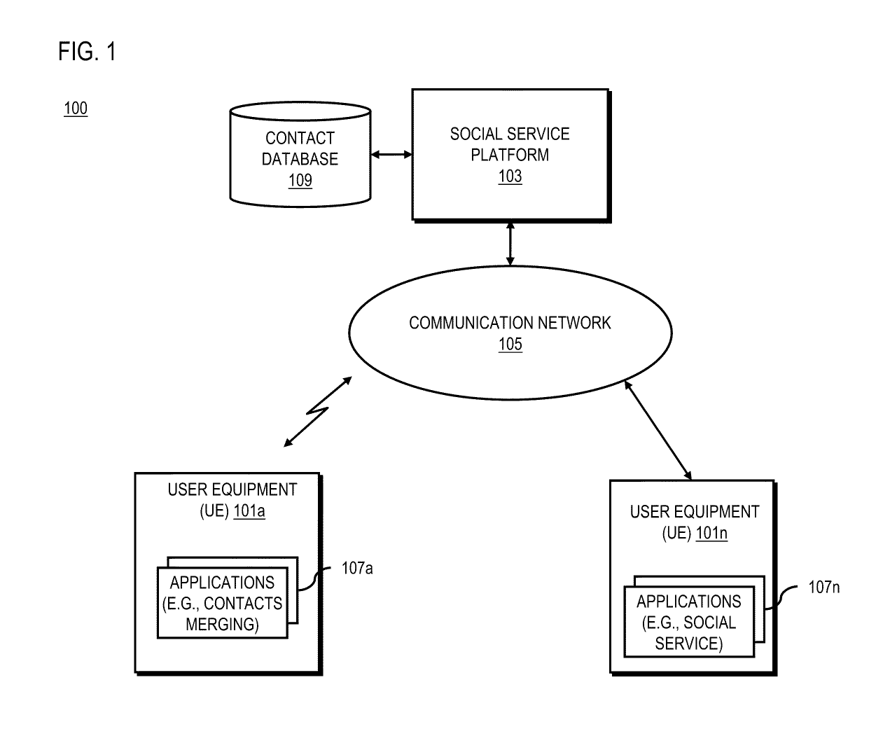

FIG. 1 is a diagram of a system 100 capable of combining contact lists, according to one embodiment. A user equipment (UE) 101 can have one or more contact lists. More information about a contact can be determined from utilizing information in other services or contact lists. In some scenarios, a contact will have a different identifier (e.g., a name, nickname, alias, etc.) representing the contact in a UE 101 contact list than the contact has in a different service (e.g., a social networking service). This can occur if a user of the UE 101 intentionally or mistakenly identifies the contact using a different identifier (e.g., using a nickname in a name slot of a contact name, typing a letter in the name twice, etc.). Additionally, this may occur if the contact goes by a different identifier in the service. For example, the contact may be identified by a nickname in the contact's everyday life, but may use the contact's full name when using the service. In some cases, information collected and stored in one contact list (e.g., stored on a UE 101) is different from the information collected and stored in a second contact list (e.g., a list utilized by the service). Thus, it can be beneficial to merge the contact lists, but it may be difficult because different identifiers could be used in each list.

Accordingly, the system 100 of FIG. 1 introduces the capability to combine contact lists using partial matching of identifiers. Under the scenario of FIG. 1, the system 100 involves UEs 101a-101n having connectivity to a social service platform 103 via a communication network 105. The UE 101 can utilize a contact list merging application 107a to merge a contact list from a contact database 109 of the social service platform 103 with a contacts list in a memory of the UE 101. Additionally, the UE 101 can access a social service of the social service platform 103 by utilizing a social service application 107n. The contacts merging application 107a can then merge a contacts list in a memory of the UE 101 with a contacts list associated with a social service platform 103. The contacts merging application 107a can begin by matching unique identifiers (e.g., phone number, e-mail, etc.) and identical full names available in each list. While this matching is taking place, identifiers that are matched can be removed from the lists that require matching and merged into a single list. The shortened lists that require matching can then be matched via a partial name matching process. In one example, this process includes parsing name identifiers associated with a contact list entry into words and matching list entries based on the words.

As shown in FIG. 1, the system 100 comprises a UE 101 having connectivity to a social service platform 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), audio/video player, digital camera/camcorder, positioning device, electronic book device, television, or any combination thereof. It is also contemplated that the UE 101 can support any type of interface to the user (such as “wearable” circuitry, etc.).

By way of example, the UE 101 and a social service platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

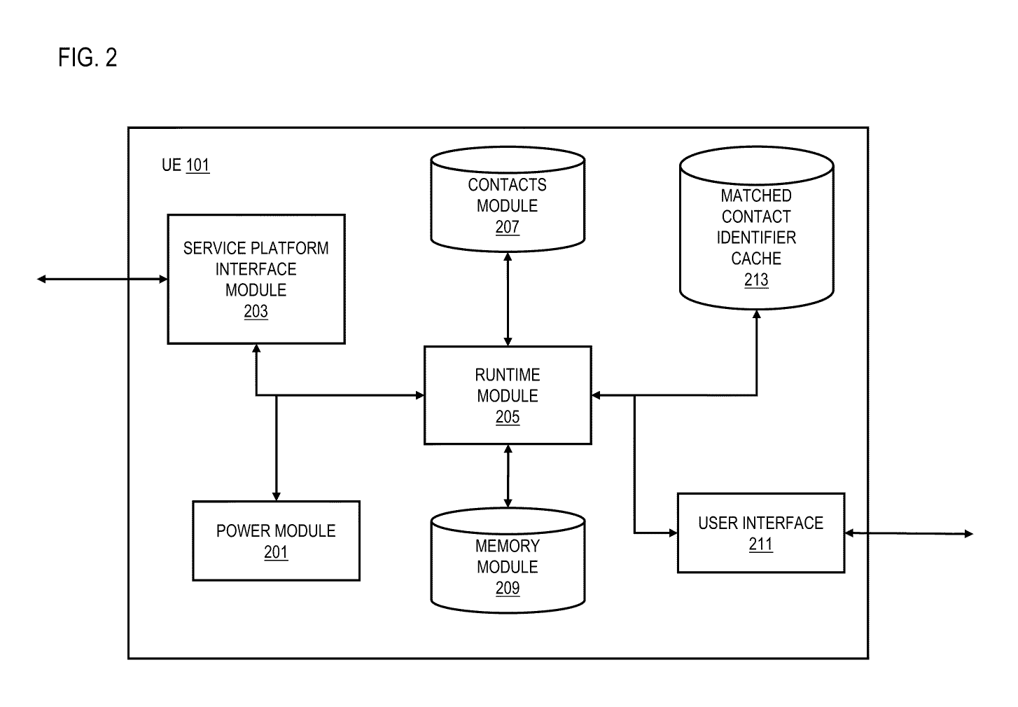

FIG. 2 is a diagram of the components of a user equipment 101, according to one embodiment. By way of example, the UE 101 includes one or more components for combining contact lists. It is contemplated that the functions of these components may be combined in one or more components or performed by other components of equivalent functionality. In this embodiment, the UE 101 includes a power module 201, a service platform interface module 203, a runtime module 205, a contacts module 207, a memory module 209, a user interface 211, and a matched contact identifier cache 213.

The power module 201 provides power to the UE 101. The power module 201 can include any type of power source (e.g., battery, plug-in, etc.). Additionally, the power module can provide power to the components of the UE 101 including processors, memory, and transmitters.

In one embodiment, a UE 101 includes a service platform interface module 203. The service platform interface module 203 is used by the runtime module 205 to communicate with a service platform such as a social service platform 103. In some embodiments, a social service application 107n can use the service platform interface module 203 to communicate with other users utilizing a service of the social service platform 103. Examples of social services include social networks such as FACEBOOK, MY SPACE, LINKEDIN, as well as instant messaging networks. Additionally, the service platform interface module 203 can retrieve contact list information from social service platform 103 and make the contact list information available to the runtime module 205. Further, the service platform interface module 203 can notify a contacts merging application 107a of a communication initiated using the service platform interface module 203.

The UE 101 can include a contacts module 207. The contacts module 207 can include one or more lists of contacts. Additionally, a contact list can include multiple entries of contacts using contact identifiers and contact information. Contact identifiers can include a full name identifier, a first name identifier, a second name identifier, a last name identifier, a nickname identifier, an alias identifier, or any other identifier used to identify a contact. Contact information can include contact identifiers and other contact records such as home phone numbers, mobile phone numbers, e-mail addresses, home address, office address, images and other information associated with contacting the contact. Also, the contacts module 207 can process contact lists from various applications 107 to be used by a contacts merging application 107a to make the contacts list compatible with the contacts merging application 107a.

In one embodiment, a UE 101 includes a user interface 211. The user interface 211 can include various methods of communication. For example, the user interface 211 can include outputs including a visual component (e.g., a screen), an audio component, a physical component (e.g., vibrations), and other methods of communication. User inputs may include a touch-screen interface, a scroll-and-click interface, a button interface, etc. A user can input a request to upload or receive object information via the user interface 211. The user interface 211 can be used by a contacts merging application 107a to display tentative matches of contacts in one contact list and another contact list. The user interface 211 can then take input from a user confirming that the two matches are correct or indicating that the tentatively matched contacts do not match.

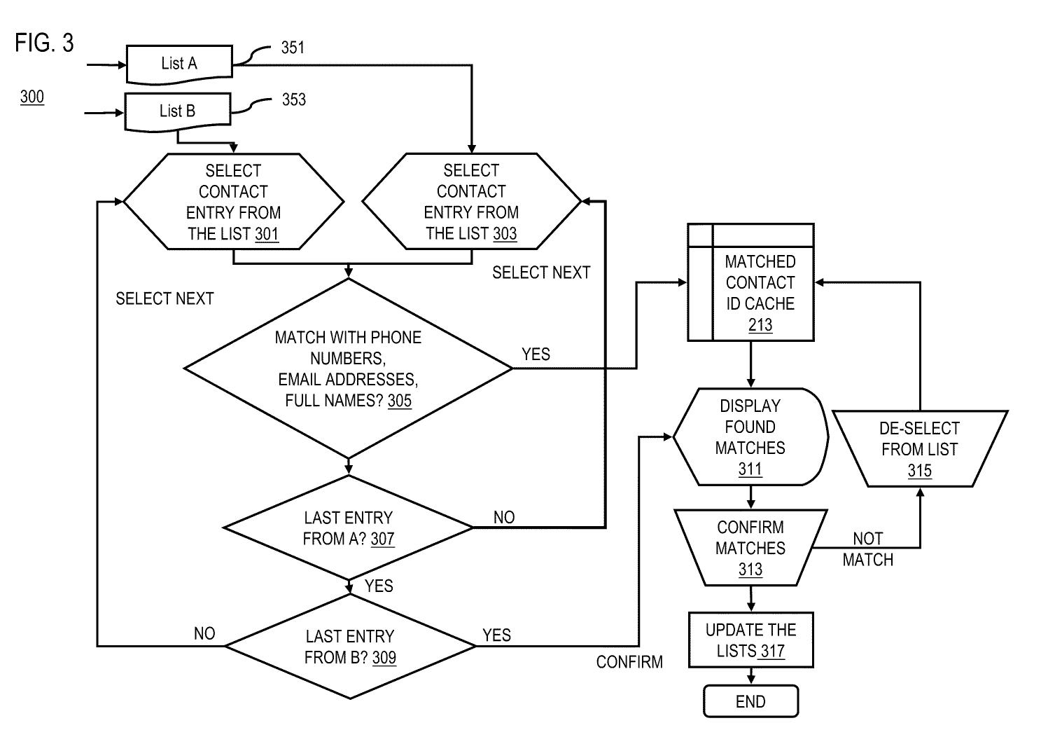

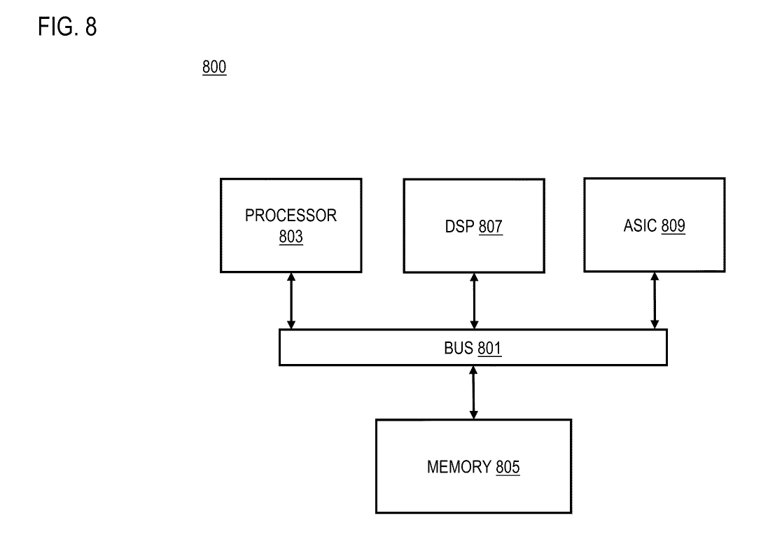

FIG. 3 is a flowchart of a process for combining contact lists using unique identifiers or full names, according to one embodiment. In one embodiment, the runtime module 205 performs the process 300 and is implemented in, for instance, a chip set including a processor and memory as shown in FIG. 8. In step 301 and 303, a contact entry from each of two contact lists, List A 351 and List B 353, is selected. In one embodiment, one of the contact lists 351, 353 belongs to a social service. The contact lists 351, 353 can include entries that can include contact identifiers and other contact records.

Next, at step 305, the runtime module 205 can match contact entries based on common unique identifiers and common full names. Unique identifiers can include a phone number identifier, an e-mail identifier, or an alias. If a unique identifier or full name of a selected entry of List A 351 matches a unique identifier or full name of the selected entry of List B 353, the entries are linked and stored in a matched contact identifier cache 213 as possible matches. If two entries match, the entries can be removed from the list of entries that can be possible matches via marking a flag.

In step 307, the process determines whether the current entry is the last entry from List A 351. If the current entry is not the last entry from List A 351, another entry that has not yet been selected for attempted matching with the current entry of List B 353 is selected at step 303; and the process is restarted from step 303. If the current entry is the last entry from List A 351, step 309 determines if the selected entry from List B 353 is the last entry from List B 353. If the selected entry is not the last entry from List B 353, then another entry of List B 353 is selected at step 301; and the process is renewed with a refreshed list of contact entries from List A 351. A list can be refreshed by updating which entries are available to be matched.

If the contact entry is the last entry from List B 353, at step 311, the runtime module 205 can utilize a user interface 211 to display found matches to a user. At step 313, the user can confirm that the contact entries match or select that the contact entries do not match via the user interface 211. If the contact entries do not match, the contact entries can be deselected, per step 315, as a possible match and removed from the matched contact identifier cache 213, a flag in each of the contact entries can be updated to allow the contact entries to be selected as possible matches. If the contact entries are confirmed as matches, List A 351 and List B 353 can be updated at step 317 with additional contact information and identifiers from the other matching entry. Alternatively, the process can be automated without user assistance based on a set of rules (e.g., automatic confirmation if two e-mail identifiers match or if two mobile phone number entries match). List A 351 and List B 353 can also be updated with a flag notifying a merging application 107a that the entries have already been matched. This flag can be reset if one of the lists is selected to be merged with another list.

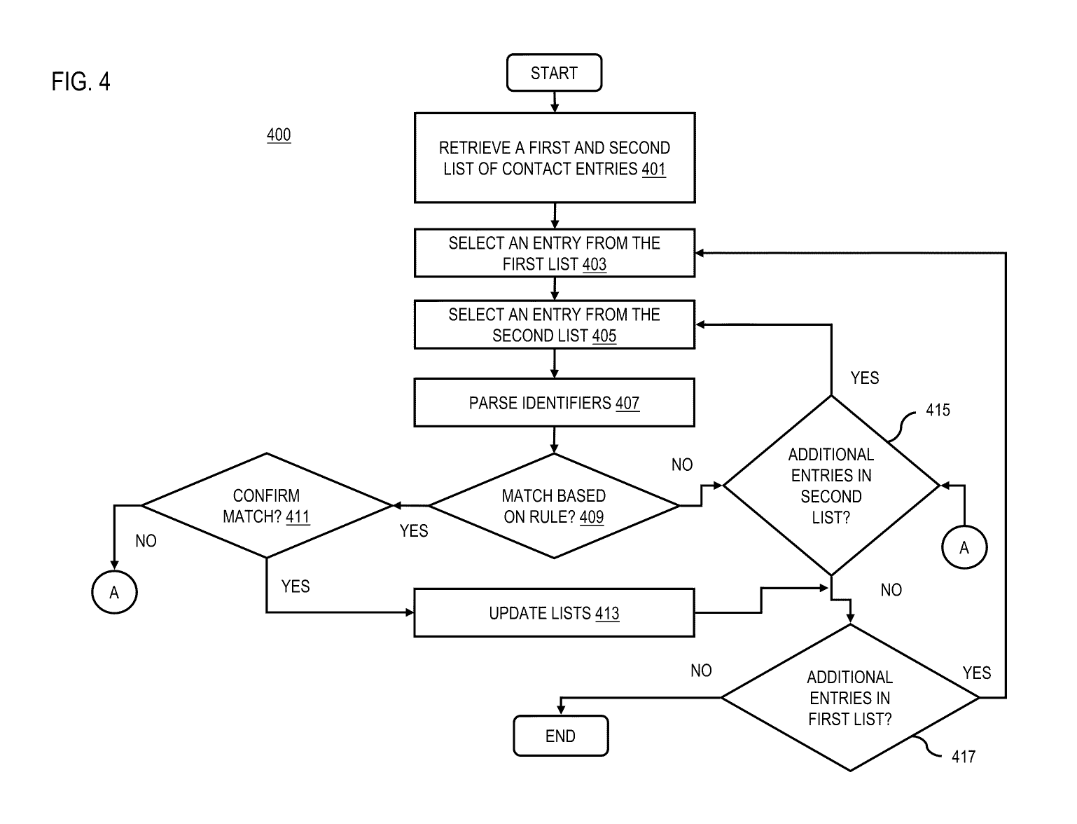

FIG. 4 is a flowchart of a process for combining contact lists using partial and ambiguous name matching, according to one embodiment. In one embodiment, the runtime module 205 performs the process 400 and is implemented in, for instance, a chip set including a processor and memory as shown in FIG. 8. At step 401, the runtime module 205 can retrieve a first and a second list of contact entries. Contact entries can have contact identifiers and other contact records. The lists can be preprocessed (e.g., processed through the process of FIG. 3) or new. One of the lists may be a contact list local to a UE 101. Another list can be a contact list retrieved from a social service platform 103 via a social service application 107n. Either can be stored in a memory of the UE 101.

At step 403, an entry from the first list is selected to be matched. Further, at step 405, an entry from the second list is selected to be matched. At step 407, identifiers corresponding to each entry can be parsed. In one embodiment, identifiers (e.g., a nickname identifier, a full name identifier, and e-mail identifier, and the like) can be parsed into words. Words can be portions of the contact identifier that can be separated for a reason. Words can be separated by the runtime module 205 based on an entry identifier containing a blank space, a period, a comma, or other such separator. Under some scenarios, characters in an identifier after an “@” symbol are ignored. In one embodiment, words can be parsed into shorter subsets (e.g., 1 character, 2 characters, 3 characters, etc.) of the words. These subsets can represent the beginning letters of the words.

At step 409, an entry from the first list is compared to an entry from the second list based on a rule. Identifiers from each list can be separated into sets of words or sets of characters based on the words. In one embodiment, the implemented rule is based on name words associated with words in a name field (e.g., fields associated with the contact entries corresponding to a name, a nickname, a first name, a second name, a last name, etc.). Under one scenario a first entry has a last name identifier and a nick name identifier. The last name identifier field is filled with “Michael Smith” and the nick name identifier field is filled with “Mikey.” Thus, three name words can be parsed, Michael, Smith, and Mikey. A second entry can have a first name identifier filled with “Mikey S. Jr.,” which can be parsed into name words Mikey, S, and Jr. In one embodiment, the rule can be set so that two entries can be flagged as matching if a name word of each entry matches and another name word partially matches. Thus, a partial name match can be made. In the above scenario, the two entries can be matched because the word Mikey matches in both and the first letter of the word Smith matches the word S. In another embodiment, the rule can be set so that a name match can be made based on a name word match at a certain tolerance (e.g., match exists if the first 4 letters are the same) and another name word partially matches. Under this scenario, a third entry's nickname identifier can contain the string “Mike Junior,” which can be parsed into name words Mike and Junior. Using this rule, the third entry can match the second entry because “Mike” and “Mikey” match to four letters and Jr and Junior match at least one letter. In yet another embodiment, the rule can be set so that a match be made based on a partial word match of one word (e.g., two name words match up to three letters). This ambiguous name match can offer more lenient matching options.

If a match is made between the two selected entries, at step 411, the match is confirmed. At the confirmation step 411, the runtime module 205 can display to a user a rendering of the matched contact entries for confirmation via a user interface 211. The user can then confirm that the two entries match or select an option that the two entries do not match. If the user confirms the match, the lists can be updated at step 413. At step 413, the contact entry information from one list can be updated to the corresponding contact entry information other list. The contact entry information can contain additional contact identifiers and contact information associated with the contact that the contact entry receiving the information did not previously have. Alternatively, the contact entry information of both of the matching entries can be stored in a third list, creating a new entry.

If a match is not detected between two entries or a potential match is determined to be not a match at the confirmation state, at step 415, the runtime module 205 determines if additional entries are in the second list. If there are additional entries, the process returns to step 405 and another entry from the second list is selected. If there are no additional entries in the second list, at step 417, the runtime module 205 determines if there are additional entries in the first list. If there are additional entries in the first list, the process returns to step 403. Otherwise, if there are no additional entries in the first list, then the process is ended.

In some embodiments, the process 400 is executed based on one rule, then executed based on another rule (e.g., a less stringent rule), updating the lists with each iteration. The lists can be instances of an original list and the merged information can be merged into one of the original lists (e.g., a list residing on the UE 101). After each iteration, matched entries can be removed from the list instances as needing to be matched or merged. Removing the list entries as needing to be matched or merged can be accomplished by flagging the entry as matched. In one embodiment, a first rule can be set to find exact matches based on unique identifiers, then a full name match, a partial name match, an ambiguous name match. If none of the above iterations result in a match for all of the records of one of the contact lists, a manual match can be done. Additionally, contacts can be added if there are no corresponding records.

In one embodiment, the process 400 is initiated based on a communication (e.g., a social network e-mail). This point in time is a natural time to determine if the contact information of the communication contact can be merged with a contact list of a user's UE 101. Once the communication is started, a search for matches is started to determine if the contact is a contact in the contact list of the UE 101. If there is a possible match, a confirmation message is displayed asking for acknowledgement of the match. Then, the available contact information of the communication contact can be added merged into the contact list of the UE 101. If no matches are found, a new contact record can be created in the contact list of the UE 101. Additionally, this allows for linking of the communication information with contact data on a UE 101.

With the above approach, a user can merge contacts between two contacts lists using minimal user interactions. In this manner, merging can be automated even though a contact on one list may have a name identifier misspelled or in a wrong field. Because the process is automated and fewer records are displayed to the user for confirmation, a UE 101 can save valuable power during the merging process.

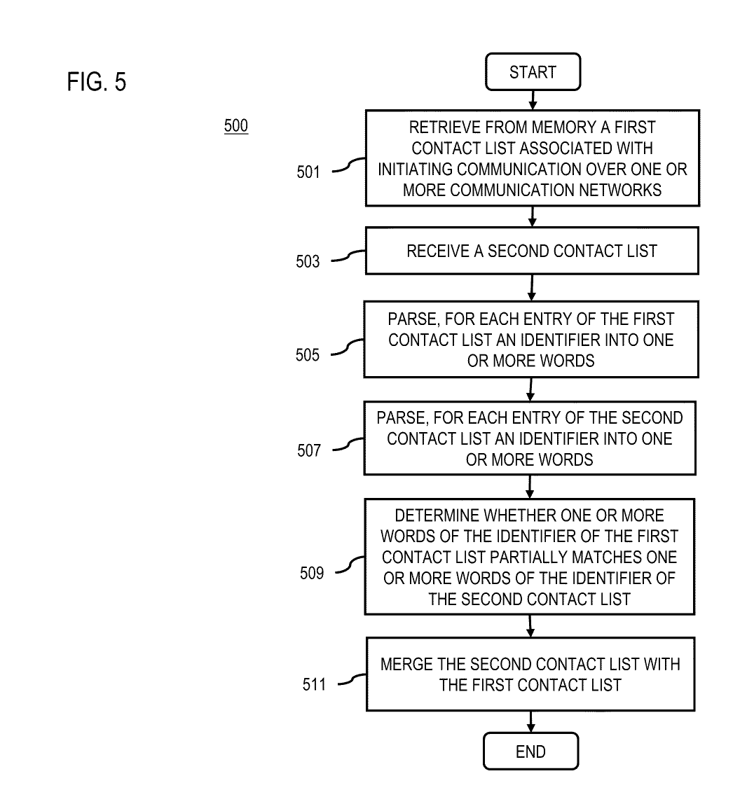

FIG. 5 is a flowchart of a process for combining contact lists, according to one embodiment. In one embodiment, the runtime module 205 performs the process 500 and is implemented in, for instance, a chip set including a processor and a memory as shown FIG. 8. In step 501, a first contact list is retrieved from memory, the first contact list is associated with communicating over one or more communication networks (e.g., a telephony network). At step 503, a second contact list is received. The second contact list can be received via the one or more communication networks, or via another communication network separate from the one or more communication networks. In one embodiment, the process is initiated when a social service communication is received. The social service communication can have a contact identifier. In one embodiment, an entry of the second contact list includes the contact identifier.

At step 505, for each entry of the first contact list, an identifier is parsed into one or more words. Additionally, at step 507, for each entry of the second contact list, an identifier is parsed into one or more words. In some embodiments, the identifier can be a name identifier associated with a contact's name (e.g., a nickname, first name, second name, last name, etc.). Additionally, these words can be parsed into smaller subsets of characters.

In one embodiment, another identifier is identified for each entry of the first contact list. In this embodiment, another entry is identified for each entry of the second contact list. It is then determined whether the other identifier of the first contact list fully matches another identifier of the second contact list. Examples of the other identifier are phone numbers and e-mail addresses. Each entry of the first contact list that fully matches an entry of the second contact list can be merged. Then each entry from the first contact list and second contact list that is matched based on the other identifier is removed from consideration for further merging.

At step 509, it is determined whether the one or more words of the identifier of the first contact list partially matches the one or more words of the identifier of the second contact list. A partial match can include a portion of one word of each selected entry matching to a certain tolerance. In one embodiment, it is determined whether a second word of the one or more words of the identifier of the first contact list fully matches a second word of the one or more words of the identifier of the second contact list. In another embodiment, it is determined whether a second word of the one or more words of the identifier of the first contact list matches to a predetermined tolerance a second word of the one or more words of the identifier of the second contact list. A predetermined tolerance can mean that the words match up to a certain amount of letters (e.g., the words match the first 3 letters or the words match the first 4 letters, etc.).

In one embodiment, a display is initiated of a rendering of the entries of identifiers that are partially matched. A user of a UE 101 can view the display. The user can then input a confirmation that the identifiers that are partially matched are associated with a same target contact. The entries are then ready for merging.

At step 511, the second contact list is merged with the first contact list. In some embodiments, the merging of contact entries is completed if the entry of the first contact list and the entry of the second contact list partially match one or more word and fully match another word. In some embodiments, the entry of the second contact list includes an information detail that is distinct from an information detail of the entry of the first contact list. An information detail can be a contact record or information. Additionally, the information detail can be distinct if the information is entered in one entry and not entered in another entry.

According to the above approach, a contact list from a UE 101 can be merged with contact details of another service. In this manner, a user of the UE 101 can utilize new ways to communicate with a contact with the additional contact information. Additionally, this allows a user to save time and effort because the user need not manually match each of the contacts. This further improves the battery life of the UE 101 when managing contact lists.

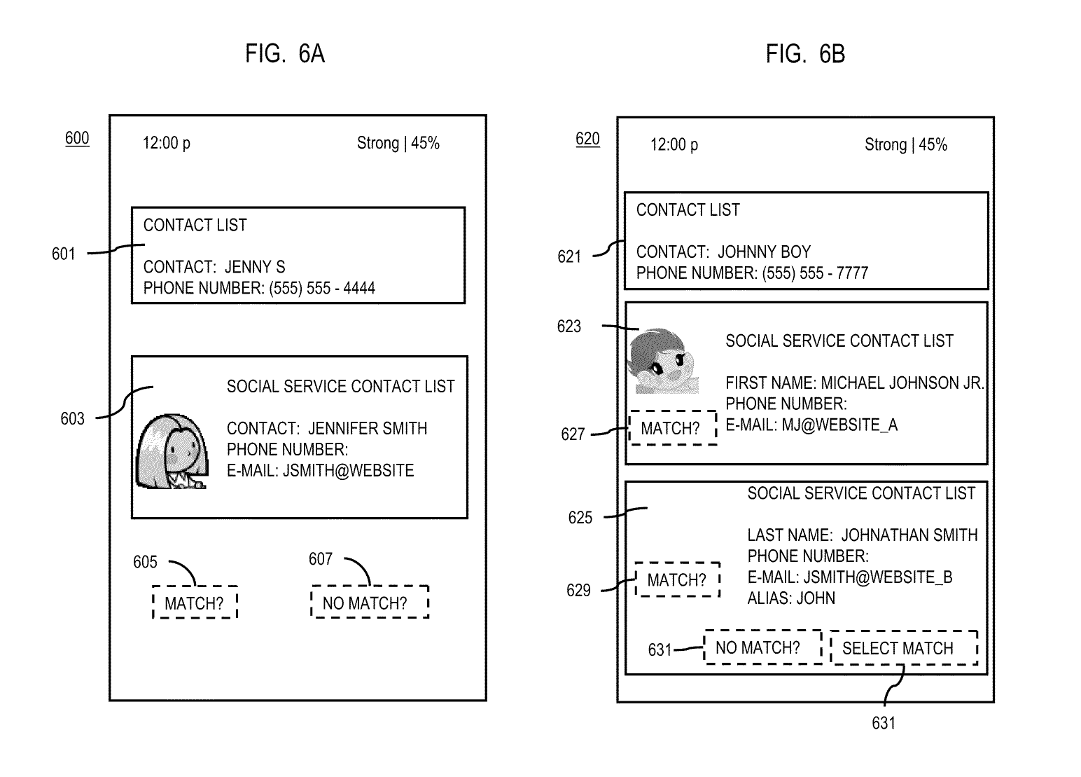

FIGS. 6A-6B are diagrams of user interfaces utilized in the processes of FIGS. 4 and 5, according to various embodiment. User interface 600 allows for confirming that two contact lists entries belong to the same target contact. A first contact list entry 601 can correspond to a local contact list on a UE 101 of the user interface 600. The user interface 600 can display available contact information. Under some scenarios, the contact entry of the first contact list 601 or a second contact list entry 603 can have an image associated with the contact that can be displayed. The second contact list entry 603 can correspond to a social service contact list. The social service contact list can be retrieved via an application 107 such as a social service application 107n. A user is able to select a matching option 605 if the contacts match and a no-match option 607 if the contacts do not match. If the contacts match, the information contained in one contact list entry can be merged with the information contained in the other contact list entry. In this example, Jennifer's e-mail and picture in the second contact list entry 603 can be added to the first contact list entry 601.

User interface 620 also allows for confirming of possible contact list entries for merging, according to one embodiment. A first contact list entry 621 associated with Johnny Boy can correspond to a local contact list on a UE 101 of the user interface 620. Additionally, a second contact list entry 623 associated with Michael Johnson Jr. can correspond to a social service contact list. Further, a third contact list entry 625 associated with Jonathan Smith can correspond to the social service contact list. When multiple possible matches are found for a single entry 621 in the first contact list, multiple possible matches can be displayed. If one of the contacts matches, a match confirmation 627, 629 corresponding to the contact match can be selected by a user. If none of the displayed contacts match, a no match 631 option can be selected. If a matched contact is selected, that contact list entry can be merged to the first contact list entry 621. If no matched contact is selected, a contact merging application 107a may resume looking for contacts. Additionally, the user may choose to select the match to the first contact list entry 621 manually. Under this scenario, the user may be able to browse or search the contacts in the social service contact list to select a contact to merge with the first contact list entry 621.

The processes described herein for combining contact lists may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

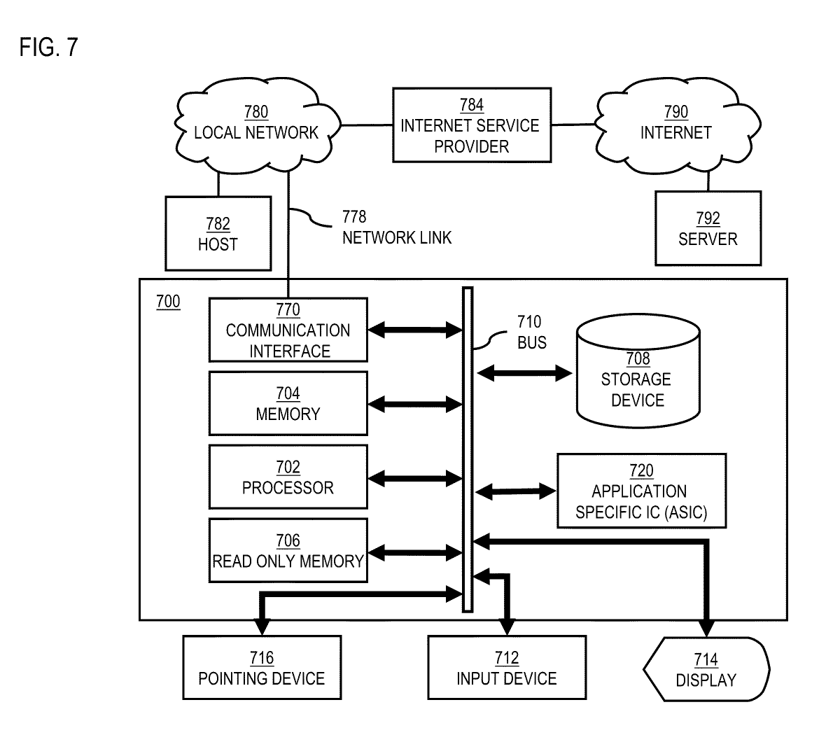

FIG. 7 illustrates a computer system 700 upon which an embodiment of the invention may be implemented. Computer system 700 is programmed (e.g., via computer program code or instructions) to combine contact lists as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of combining contact lists.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to combining contact lists. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for combining contact lists. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for combining contact lists, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 to the UE 101.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790. A computer called a server host 792 connected to the Internet hosts a process that provides a service in response to information received over the Internet. For example, server host 792 hosts a process that provides information representing video data for presentation at display 714.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set 800 upon which an embodiment of the invention may be implemented. Chip set 800 is programmed to combine contact lists as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of combining contact lists.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to combine contact lists. The memory 805 also stores the data associated with or generated by the execution of the inventive steps.

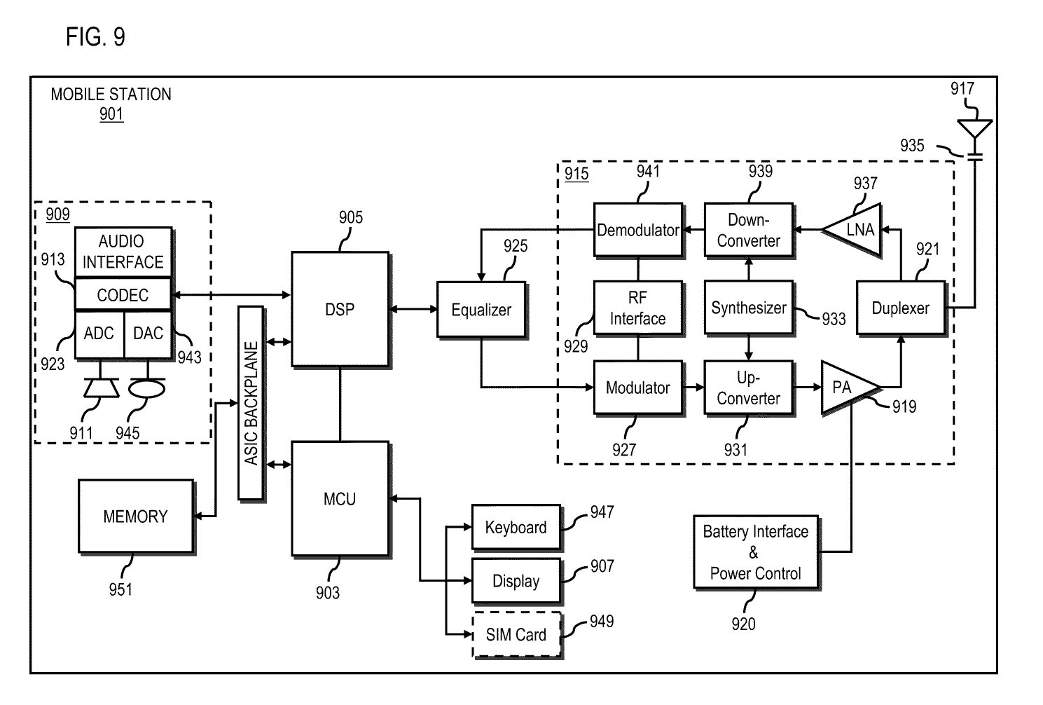

FIG. 9 is a diagram of exemplary components of a mobile terminal (e.g., handset) for communications, which is capable of operating in the system of FIG. 1, according to one embodiment. In some embodiments, mobile terminal 900, or a portion thereof, constitutes a means for performing one or more steps of combining contact lists. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application, the term “circuitry” would also cover an implementation of merely a processor (or multiple processors) and its (or their) accompanying software/or firmware. The term “circuitry” would also cover, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of combining contact lists. The display unit 907 includes display circuitry configured to display at least a portion of a user interface of the mobile terminal (e.g., mobile telephone). Additionally, the display unit 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to combine contact lists. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
retrieving from memory a first contact list associated with initiating communication over one or more communication networks;
receiving a second contact list; and
merging the second contact list with the first contact list by,
parsing, for each entry of the first contact list, an identifier into one or more words,
parsing, for each entry of the second contact list, an identifier into one or more words, and
determining whether the one or more words of the identifier of the first contact list partially matches the one or more words of the identifier of the second contact list.

2. A method of claim 1, further comprising:
determining whether a second word of the one or more words of the identifier of the first contact list fully matches a second word of the one or more words of the identifier of the second contact list; and
completing merging, for each entry of the first contact list and second contact list that partially matches and fully matches.

3. A method of claim 1, further comprising:
identifying another identifier for each entry of the first contact list;
identifying another identifier for each entry of the second contact list;
determining whether the another identifier of the first contact list fully matches the another identifier of the second contact list;
merging, for each entry of the first contact list and second contact list that fully matches;
removing each entry from the first contact list that is fully matched from consideration for further merging; and
removing each entry from the second contact list that is fully matched from consideration for further merging.

4. A method of claim 1, further comprising:
receiving a social service communication with a contact identifier, wherein an entry of the second contact list comprises the contact identifier; and
initiating merging upon receiving the communication.

5. A method of claim 1, further comprising:
initiating display of a rendering of the entries of identifiers partially matched;
receiving a confirmation that the identifiers partially matched are associated with a same target; and
completing merging of the identifiers partially matched.

6. A method of claim 1, wherein the entry of the second contact list comprises an information detail that is distinct from an information detail of the entry of the first contact list.

7. A method of claim 1, further comprising:
determining whether a second word of the one or more words of the identifier of the first contact list matches to a predetermined tolerance a second word of the one or more words of the identifier of the second contact list.

8. A method of claim 1, wherein the second contact list is received over the one or more communication networks or another communication network separate from the one or more communication networks.

9. An apparatus comprising:
at least one processor; and
at least one memory including computer program code,
the at least one memory and the computer program code configured to, with the at least one processor, cause the apparatus to perform at least the following,
retrieve from memory a first contact list associated with initiating communication over one or more communication network,
receive a second contact list, and
merge the second contact list with the first contact list by causing the apparatus to:
parse, for each entry of the first contact list, an identifier into one or more words,
parse, for each entry of the second contact list, an identifier into one or more words, and
determine whether the one or more words of the identifier of the first contact list partially matches the one or more words of the identifier of the second contact list.

10. An apparatus of claim 9, wherein the apparatus is further caused to:
determine whether a second word of the one or more words of the identifier of the first contact list fully matches a second word of the one or more words of the identifier of the second contact list; and
complete merging, for each entry of the first contact list and second contact list that partially matches and fully matches.

11. An apparatus of claim 9, wherein the apparatus is further caused to:
identify another identifier for each entry of the first contact list;
identify another identifier for each entry of the second contact list;
determine whether the another identifier of the first contact list fully matches the another identifier of the second contact list;
merge, for each entry of the first contact list and second contact list that fully matches;
remove each entry from the first contact list that is fully matched from consideration for further merging; and
remove each entry from the second contact list that is fully matched from consideration for further merging.

12. An apparatus of claim 9, wherein the apparatus is further caused to:
receive a social service communication with a contact identifier, wherein an entry of the second contact list comprises the contact identifier; and
initiate merging upon receiving the communication.

13. An apparatus of claim 9, wherein the apparatus is further caused to:
initiate display of a rendering of the entries of identifiers partially matched;
receive a confirmation that the identifiers partially matched are associated with a same target; and
complete merging of the identifiers partially matched.

14. An apparatus of claim 9, wherein the entry of the second contact list comprises an information detail that is distinct from an information detail of the entry of the first contact list.

15. An apparatus of claim 9, wherein the apparatus is further caused to:
determine whether a second word of the one or more words of the identifier of the first contact list matches to a predetermined tolerance a second word of the one or more words of the identifier of the second contact list.

16. apparatus of claim 9, wherein the second contact list is received over the one or more communication networks or another communication network separate from the one or more communication networks.

17. A computer-readable storage medium carrying one or more sequences of one or more instructions which, when executed by one or more processors, cause an apparatus to perform at least the following:
retrieve from memory a first contact list associated with initiating communication over one or more communication network;
receive a second contact list; and
merge the second contact list with the first contact list by causing the apparatus to:
parse, for each entry of the first contact list, an identifier into one or more words,
parse, for each entry of the second contact list, an identifier into one or more words, and
determine whether the one or more words of the identifier of the first contact list partially matches the one or more words of the identifier of the second contact list.

18. A computer-readable storage medium of claim 17, wherein the apparatus is further caused to:
determine whether a second word of the one or more words of the identifier of the first contact list fully matches a second word of the one or more words of the identifier of the second contact list; and
complete merging, for each entry of the first contact list and second contact list that partially matches and fully matches.

19. A computer-readable storage medium of claim 17, wherein the apparatus is further caused to:
identify another identifier for each entry of the first contact list;
identify another identifier for each entry of the second contact list;
determine whether the another identifier of the first contact list fully matches the another identifier of the second contact list;
merge, for each entry of the first contact list and second contact list that fully matches;
remove each entry from the first contact list that is fully matched from consideration for further merging; and
remove each entry from the second contact list that is fully matched from consideration for further merging.

20. A computer-readable storage medium of claim 17, wherein the apparatus is further caused to:
receive a social service communication with a contact identifier, wherein an entry of the second contact list comprises the contact identifier;
initiate merging upon receiving the communication;
initiate display of a rendering of the entries of identifiers partially matched;
receive a confirmation that the identifiers partially matched are associated with a same target; and
complete merging of the identifiers partially matched.
